(19) United States
(12) Patent Application Publication
(10) Pub. No.: US 2010/0108260 A1
(43) Pub. Date: May 6, 2010

(54) Two-Component Adhesive

(75) Inventors: Alfred Rasche, Dormagen (DE); Catherine Baron, Meyenheim (FR); Fabian Leuthard, Merenschwand (CH); Damien Ferrand, Sierentz (FR); Karl Huber, Neuenkirch (CH); Adrian Schulthess, Tentlingen (CH)

Correspondence Address: SHOEMAKER AND MATTARE, LTD, 10 POST OFFICE ROAD - SUITE 100, SILVER SPRING, MD, 20910, US

(73) Assignee: NOLAX AG, Sempach Station (CH)

(21) Appl. No.: 12/524,473

(22) PCT Filed: Feb. 5, 2008
(86) PCT No.: PCT/EP2008/051381

§ 371 Date: Jul. 24, 2009

(30) Foreign Application Priority Data
Feb. 6, 2007 (EP) 07101841.0

(51) Int. Cl. C09J 175/04; C08G 18/00; C08L 75/04

(52) U.S. Cl. 156/331.4; 528/62; 524/589

(57) ABSTRACT

Two-component adhesive for bonding wood materials, comprising an isocyanate-containing component A and an amine-containing component B, component A comprising an isocyanate-terminated prepolymer having an isocyanate functionality of ≧1.7, preferably of 1.7<f_{NC0}<3, more preferably in the range from 2 to 3; and component B comprising at least one diamine and/or polyamine, preferably a polyetherdiamine and/or polyether-polyamine. An adhesive of this kind permits not only surprisingly advantageous properties on the part of the resulting bond but also bonds which can be accomplished very rapidly.

The invention relates to a two-component adhesive for bonding wood materials.

In recent times polyurethane adhesives have frequently been used for the bonding of wood materials, including, more particularly, in load-bearing glued wood construction (civil engineering wood construction) such as, for example, for the fabrication of construction members (glued laminated beams, wall elements, etc.). In such applications both two-component and one-component, moisture-curing systems are employed. In the case of the latter systems, application of the adhesive is followed by a preliminary reaction between isocyanates and moisture from the ambient air or from the substrate: from part of the isocyanate used, with elimination of carbon dioxide, the corresponding amine is formed, and subsequently reacts with isocyanate to produce a urea bond, eliminating CO₂ as it does so.

The reaction of aromatic isocyanates and hydroxyl groups (from water or alcohols) is faster by several orders of magnitude than the corresponding reaction of aliphatic isocyanates. However, the aromatic system makes aromatic isocyanates susceptible to oxidation and intrinsically less lightfast. In certain applications, moreover, the urethane reaction is still not quick enough—as, for example, for mass production of assembled parts with high throughput. There are limits on acceleration in the case of one-component systems in any case. First, the diffusion of the water molecules from the substrate or from the air is often rate-determining. Second, highly accelerated formulations have a tendency to form foam, since the CO₂ formed remains enclosed. For numerous applications, particularly in the exterior sector, moreover, high heat resistance and water resistance qualities are required.

It is an object of the present invention, therefore, to avoid the disadvantages of the known art and thus, more particularly, to provide a two-component adhesive for bonding wood materials that allows bonds to be accomplished which very rapidly acquire a load-bearing capacity, the strength and resistance properties of the resulting bond being at least similar to, if not, indeed, better than, those as known for the polyurethane adhesives discussed above. Moreover, the two-component adhesive ought to be extremely lightfast.

This object is achieved by the subject matter of the independent claims.

A two-component adhesive of the invention for bonding wood materials comprises an isocyanate-containing component A and an amine-containing component B. Component A here comprises an isocyanate-terminated prepolymer or prepolymer mixture having an isocyanate functionality of ≧1.7, preferably of 1.7<f_{NCO}<3, more preferably in the range from 2 to 3. With particular preference the isocyanate-terminated prepolymer or prepolymer mixture is liquid or pasty at room temperature (20° C.), but not solid. The isocyanate content of the prepolymer is more particularly 6% to 33%, preferably 8% to 25%, more preferably 12% to 18% by weight. Component B comprises at least one diamine and/or polyamine, preferably a polyetherdiamine and/or polyetherpolyamine. With particular preference component B, more particularly the diamine and/or polyamine, is liquid or pasty at room temperature (20° C.), but not solid. With further preference component B contains substantially no hydroxyl groups.

The invention provides, accordingly, a two-component adhesive in which the crosslinking of the isocyanate-containing prepolymer of component A is brought about by means of amines which are provided systematically in component B. This results in a plurality of advantages as compared with the prior art: (1.) In comparison to the one-component polyurethane systems described above, there is no need first to generate amines by hydrolysis of excess isocyanate—instead, the amines are provided as such, which massively accelerates the reaction. The moisture contents of the substrates and/or of the air are therefore not relevant for the bonding process. As a result it is also possible to bond substrates such as glass, metals, etc. without problems. The absence of CO₂ is likewise beneficial for the bond, since there is no need for opposing pressure and there are also no bubbles to weaken the cohesion of the joint. (2.) In comparison to the two-component polyurethane systems described above it is possible, if lightfastness is required, to use, appropriately, exclusively aliphatic amines, which also leads to crosslinking which tends to be quicker, with the formation of urea bridges. By virtue of the present invention, therefore, without a loss of quickness in the reaction system, and instead, in fact, with acceleration, it becomes possible to omit very largely—and preferably completely—aromatic amines, more particularly polymers containing aminobenzoate. In the case of mechanical processing, it is possible to achieve very short cycle times in bonding. Moreover, there is no need at all for the presence of monoamines. Surprisingly, in addition, ceteris paribus, probably because of the greater thermodynamic stability of the urea bond as compared with the urethane bond, increases in the heat stability and water resistance are obtained.

In particularly preferred embodiments the isocyanate-terminated prepolymer or prepolymer mixture in component A is a polyurethane or polyurea prepolymer, where appropriate as a blend with further isocyanates, examples being monomeric diisocyanates, polymeric isocyanates, or monofunctional isocyanates. Where appropriate it is also possible to do entirely without the presence of prepolymers and, instead, the corresponding reactants (diisocyanates/polyisocyanates on the one hand and diols/polyols and/or diamines/polyamines on the other) for the generation of a prepolymer can be present in component A. Polyurethane prepolymers and/or polyurethane prepolymer mixtures are preferred in the context of the invention: they allow the effective adhesion, known from the above-discussed prior art, of polyurethane compositions to wood materials to be utilized further.

Suitable polyurethane or polyurea prepolymers and their preparation are known per se to the skilled person. Mention is made in particular of:

### Isocyanates

Polyisocyanates are essential for the preparation of polyurethanes and polyureas. The general empirical formula of polyisocyanates is R—(NCO)ₙ, with n≦2, and with R denoting an aromatic or aliphatic group. Polyisocyanates that react with hydroxyl groups form polyurethanes; polyisocyanates that react with amine groups form polyureas.

Polyisocyanates used are preferably diisocyanates, with particular preference selected from the group consisting of 4,4′-methylenebis(phenyl isocyanate) (MDI); tolylene diisocyanate (TDI); m-xylylene diisocyanate (XDI); hexamethylene diisocyanate (HDI); methylenebis(4-cyclohexyl diisocyanate) (HDMI); naphthalene 1,5-diisocyanate (NDI); 3,3′-dimethyl-4,4′-biphenyl diisocyanate (TODI); 1,4-diisocyanatobenzene (PPDI), phenyl 1,4-diisocyanate; trimethylhexamethylene diisocyanate (TMDI); isophorone diisocyanate (IPDI); 1,4-cyclohexyl diisocyanate (CHDI); diphenyl ether 4,4′-diisocyanate; p,p′-diphenyl diisocyanate; lysine diisocyanate (LDI); 1,3-bis(isocyanatomethyl)cyclohexane; polymethylpolyphenyl isocyanate (PMDI); and isomers and/or mixtures thereof.

Particular preference is given to MDI and polyMDI mixtures. Methylene-bridged polyphenyl polyisocyanate mixtures normally contain about 20 to about 100 percent by weight of MDI isomers (typically about 20 to about 95 percent by weight of which are accounted for by the 4,4′ isomer), the remainder being formed by polymethylenepolyphenyl isocyanates of higher functionality (typically approximately between 2.1 and 3.5) and higher molecular weight. Isocyanate mixtures of this kind are available commercially and/or can easily be prepared in accordance with U.S. Pat. No. 3,362,979.

The isocyanates can of course be used in the form of higher homologues, such as in isocyanurate, carbodiimide, allophanate, biuret or uretdione form, for example.

### Prepolymers

### Polyurethane Prepolymers

Polyurethane prepolymers are prepared by reacting polyols with the abovementioned isocyanates. Suitable polyols are familiar to the skilled person. In the context of the invention they typically have a molecular weight of about 500 to about 6000 and/or two to four hydroxyl groups. Particularly preferred polyols are polyesters, polyethers, polythioethers, polyacetals and polycarbonates having in each case two to four hydroxyl groups. Preferred polyethers in the context of the invention are known per se to the skilled person and can be prepared, for example, by polymerizing epoxides such as ethylene oxide, propylene oxide, butylene oxide, tetrahydrofuran, styrene oxide or epichlorohydrin in the presence of BF₃, or by addition of epoxides, more particularly of ethylene oxide or propylene oxide, to molecules containing reactive hydrogens, such as water, alcohol or amines, for example (examples being low molecular weight diols, triols or tetraols; 4,4′-di hydroxydiphenylpropane; aniline; ammonia; ethanolamine; ethylenediamine). Polypropylene glycol and polytetramethylene glycol (PTMG or PTMEG) are presently preferred.

In prepolymer preparation it is also possible to employ chain extenders that are known per se, more particularly diols/polyols of low molecular weight (typically less than 400 g/mol). Mention may be made in particular of ethylene glycol, propylene glycol, butane glycol, pentane glycol, hexane glycol, benzyl glycol, xylene glycol, water, 1,4-butanediol, 1,3-butanediol, 2,3-dimethyl-2,3-butanediol, dipropylene glycol and tripropylene glycol, diethylene glycol and triethylene glycol, N—N′-bis(2-hydroxypropyl)aniline (DHPA), 1,4-di(2-hydroxyethyl)hydroquinone (HQEE), diethanolamine, triethanolamine, trimethylolpropane and glycerol.

Polyalkenylpolyols, polyetherpolyols or polyesterpolyols or mixed polyesterpolyetherpolyols having preferably 2 or 3 hydroxyl end groups can be reacted with a well-defined excess of isocyanates to give NCO-terminated urethane prepolymers. They are also available commercially, for example from BAYER AG, e.g. under the commercial brand names Desmodur® E22 or E23. Distilled products, where the removal of the excess diisocyanate leads to f_{NCO}=2, are likewise known and can be used.

### Polyurea Prepolymers

Polyurea prepolymers are prepared in conventional manner by reacting polyamines having ≧2 amine groups with a well-defined excess of difunctional or polyfunctional isocyanate compounds to give NCO-terminated urea prepolymers.

In the context of the invention, however, polyurea prepolymers are less preferred than polyurethane prepolymers, since they tend to gel at room temperature as a result of the formation of hydrogen bonds.

### Amines

### Polyetherpolyamines

As a polymeric polyamine component it is possible with preference to use compounds having a functionality of 2 to 4, with more than 50% of the active hydrogen atoms, more particularly, being formed by primary or secondary amines. Mention may be made in particular of the following: polyoxyalkylenamines such as, for example, polyoxypropylene-diamines, polyoxyethylenediamines, polytetramethylene ether diamines, polyoxypropylenetriamines, polyoxyethylenetriamines (known under the trade name Jeffamine° from Huntsman); and also, if aromatic components are tolerable for a specific application, the following: polyethylene glycol di(p-aminobenzoate); polyethylene glycol di(o-aminobenzoate); polyethylene glycol di(m-aminobenzoate); polytetramethylene glycol di(p-amino-benzoate); polytetramethylene glycol di(o-aminobenzoate), polytetramethylene glycol di(m-aminobenzoate). As polyamines it is possible to use polyethylene oxide-polypropylene oxide polyethers, more particularly those having a functionality of approximately two to approximately three and/or having a molecular weight of approximately 200 g/mol to approximately 6000 g/mol (described, for example, in U.S. Pat. No. 4,433,067). It is also possible of course to use mixtures of amine-terminated polyethers in the context of the invention.

Preference is given to using polyoxyalkylenediamines having an average molecular weight in the range from about 150 g/mol to about 7500 g/mol, preferably in the range from about 250 g/mol to about 6000 g/mol.

### Amines as Chain Extenders

In the context of the invention it is also possible to use aminic chain extenders, preferably those having a molecular weight of typically less than 400 g/mol. Mention may be made in particular of aliphatic diamines, as described for example in U.S. Pat. No. 4,246,363 and U.S. Pat. No. 4,269,945. Additionally, a chain-extending aliphatic diamine can be selected from the group consisting of ethylenediamine; neopentanediamine; 1,2- and 1,3-propanediamine; 1,6-hexamethylenediamine; 1,8-octamethylenediamine; 1,12-dodeca-methylenediamine; cyclohexyldiamine; 4,4′-bis(para-aminocyclo-hexyl)methane; 2,2′-dimethyl-4,4′-methylenebis(cyclohexylamine) (dimethyldicyclane); isophoronediamine; 4,7-dioxadecane-1,10-diamine; 4,7,10-trioxadecane-1,13-diamine, tetramethylethylenediamine; pentamethyldiethylenetriamine; dimethylcyclohexylamine; tetramethyl-1,3-butanediamine; pentamethyldipropylenetriamine; bis(dimethylaminoethyl ether)triethylene glycol diamine; 4,4′-methylenebis(2-ethyl-6-methylcyclohexylamine) (M-MECA); 4,4′-methylenebis(2,6-diethyl cyclohexylamine) (MDECA); 4,4′-bis(sec-butylamino)dicyclohexyl-methane (available commercially as Clearlink® 1000) and monomers thereof; 3,3′-dimethyl-4,4′-bis(sec-butylamino)dicyclohexylmethane (available commercially as Clearlink® 3000) and monomers thereof; N,N′-diisopropylisophoronediamine (available commercially as Jefflink® 754); amines of aspartamic acid such as, for example, N,N′-diethyl maleate-2-methylpentamethylenediamine (available commercially as Desmophen® NH-1220), N,N′-diethyl maleate-aminodicyclohexylmethane (available commercially as Desmophen® NH-1420), and N,N′-diethyl maleate-aminodimethyldicyclohexylmethane (available commercially as Desmophen® NH-1520).

Aromatic diamines as well (as described for example in U.S. Pat. No. 4,659,747) can be used as chain extenders in the context of the invention, subject to the proviso of the aforementioned light stability requirements for certain applications. The following may be mentioned specifically: dimethylbenzylamine; diethylbenzylamine; 1,2-dimethylimidazole; 2-methylimidazole; 1,2-, 1,3- or 1,4-bis(sec-butylamino)benzene (available commercially as Unilink® 4100); 4,4′-bis(sec-butylamino)di-phenylmethane (available commercially as Unilink® 4200); trimethylene glycol di(p-aminobenzoate) (available commercially as Versalink 740M); trimethylene glycol di(o-aminobenzoate); trimethylene glycol di(m-aminobenzoate); polyethylene glycol di(p-aminobenzoate); polyethylene glycol di(o-aminobenzoate); polyethylene glycol di(m-aminobenzoate); polytetramethylene glycol di(p-aminobenzoate); polytetramethylene glycol di(o-aminobenzoate); polytetramethylene glycol di(m-aminobenzoate); aromatic diamines such as, for example, 3,5-diethyl-2,4-toluenediamine and 3,5-diethyl-2,6-toluenediamine (available commercially as Ethacure® 100) and 3,5-dimethylthio-2,4-toluenediamine and 3,5-dimethylthio-2,6-toluenediamine (available commercially as Ethacure® 300); 4,4′-methylenebis(2-chloroaniline); diethylenetriamines; triethylenetetramines; tetraethylenepentamine; methylenedianiline (MDA); m-phenylene-diamine; diethyltoluenediamine; 4,4′-methylenebis(3-chloro-2,6-diethylbenzylamine) (MCDEA); diethyltoluenediamines (DETDA); 4,4′-methylenebis(2-ethyl-6-methylanilines) (NMMEA); 4,4′-methylenebis(2,6-diethylaniline) (MDEA); 4,4′-methylenebis(2-isopropyl-6-methylaniline) (MMIPA); 4,4′-bis(sec-butylamino) diphenylmethanes; phenylenediamines; methylenebis-ortho-chloroaniline (MBOCA); 4,4′-methylenebis(2-methylaniline) (MMA); 4,4′-methylenebis(2-chloro-6-ethylaniline) (MCEA); 1,2-bis(2-aminophenylthio)ethane; N,N′-dialkyl-p-phenylenediamine; 4,4′-methylenebis(2,6-diisopropylaniline) (MDIPA); and dimethylthiotoluenediamine (2,4 and 2,6 isomers) (DMTDA); 4-chloro-3,5-diaminobenzoic acid isobutyl ester (CDABE), and mixtures thereof.

The mixing ratio of the aforementioned chain extenders with the polyamines can easily be harmonized in routine tests by the skilled worker to the desired proportion of hard segments and soft segments. In this case account should be taken of the customary art requirements concerning the miscibility of the components.

The aforementioned primary polyamines can be modified further in the context of the invention in a manner which is customary in the art, such as, for example, with epoxides (U.S. Pat. No. 6,723,821), with acrylates (via a Michael addition, as described, for example, in U.S. Pat. No. 5,359,123 and U.S. Pat. No. 5,192,814), or else with alkoxysilanes (preferably with aminosilanes, as described, for example, in WO 02059224), and also with isocyanatosilanes, epoxysilanes or acrylatosilanes.

Through the incorporation of the alkoxysilyl compounds into the isocyanate component and/or amine component it is possible to obtain these 2K polyurea adhesives with an improved profile of properties in terms of adhesion, water resistance or acid resistance.

Particularly preferred amines in component B are polyoxypropylenediamines, preferably those having an average molecular weight of about 2000 g/mol (available commercially, for example, under the trade name Jeffamine® D-2000 as per CAS 9046-10-0; Huntsman Corporation, Houston, Tex.); primary, branched polyethertriamines, preferably having an average molecular weight of about 5000 g/mol (available commercially, for example, under the trade name Jeffamine® T-5000 as per CAS 64852-22-8; Huntsman Corporation, Houston, Tex. (USA)); substituted, more particularly aromatic diamines such as, for example, diethyltoluenediamine (available commercially under the trade name Härter DT or Härter VP LS 2214; Bayer AG, Leverkusen (DE)) or N,N′-dialkylaminodiphenylmethane (available commercially under the trade name Unilink™ 4200 Diamine; UOP GmbH, Erkrath (DE)).

The functionality of the NCO-terminated prepolymers, more particularly of the urethane prepolymers, is ≧1.7, preferably 1.7<f_{NCO}<3, more preferably in the range from 2 to 3. Functionalities >2 are explained not only by additionally present, free isocyanates but also by allophanate groups, which can come about through reaction of urethane groups with further NCO units; prepolymers of this kind are therefore often referred to in the art as “quasi-prepolymers”. In the course of the further reaction of component B, allophanate groups in component A are cleaved back into a urethane and free isocyanate.

In preferred embodiments the stoichiometric ratio of isocyanate groups in component A to amine groups in component B is about 0.5 to about 2, preferably about 0.9 to about 1.2, more preferably about 1.

By way of the selection and, where appropriate, combination of different diamines or polyamines it is easily possible for the skilled person, in routine tests, to adjust key properties of the two-component adhesive exclusively by way of component B, such as, for example, the elasticity, water resistance, reaction rate, etc.; component A, in contrast, can be retained, which allows considerable flexibility both from the production standpoint, for the manufacturer, and in provision as well, for the user (system with different components B; see below).

The compositions of the invention can of course comprise the further additives customary in the art, of the kind generally customary in the polyurethane/polyurea industry. For example: plasticizers, examples being esters of organic carboxylic acids or their anhydrides, phthalates such as dioctyl phthalate or diisodecyl phthalate, for example, adipates, such as dioctyl adipate, for example, sebacates, organic phosphoric and sulphonic esters, polybutenes and other compounds that do not react with isocyanates; solvents; organic and inorganic fillers, such as, for example, ground or precipitated calcium carbonates, which if appropriate have been coated with stearates, or carbon blacks, kaolins, aluminas, silicas and PVC powders; fibres, made of polyethylene or of polyamide, for example; pigments; rheology modifiers such as, for example, thickeners, examples being urea compounds, polyamide waxes, bentonites or fumed silicas; adhesion promoters, more particularly silanes such as vinylsilanes, isocyanatosilanes in the isocyanate component and aminosilanes, reacted with aldehydes to form aldiminosilanes, in the amine component; siccatives such as, for example, p-tosyl isocyanate and other reactive monoisocyanates, vinyltrimethoxysilane, orthoformic esters, calcium oxide or molecular sieves (e.g. zeolites); heat, light and UV radiation stabilizers; flame retardants; surface-active substances such as, for example, wetting agents, flow control agents, devolatilizers or defoamers; fungicides or fungal growth inhibitors; and also other substances commonly employed in the polyurethane industry.

With regard to such additives reference is made to Polyurethane Handbook 2nd edition, Günter Oertel (Editor), Hanser Publishers Munich 1994, pages 98 to 128, whose disclosure content with regard to additives common in the art is hereby included by reference as part of the disclosure content of the present invention.

With aforementioned two-component adhesives it is readily possible to meet various standard specifications in wood construction, as for example in the context of the processing of beech; for example:
a bond strength C1 to DIN EN 12765 (precise-fit joint) of ≧10N/mm², preferably of ≧12N/mm²; and/or
a bond strength C1 to DIN EN 12765 (0.5 mm joint) of ≧7.5N/mm², preferably of ≧9N/mm²; and/or
a water resistance C3 (conditioning sequence 3) to DIN EN 12765 (precise-fit joint) of ≧4N/mm², preferably of ≧5N/mm²; and/or
a water resistance C3 to DIN EN 12765 (0.5 mm joint) of ≧3N/mm², preferably of ≧4N/mm²; and/or
a heat resistance to DIN EN 14257 (precise-fit joint) of ≧7N/mm², preferably of ≧9N/mm².

The invention further relates to a method of bonding wood materials, more particularly in structural wood construction, comprising applying an above-described two-component adhesive to at least one of the substrates to be joined. Suitable further substrates include primarily the following: metals, glass, ceramic, plastics, textiles. With particular advantage it is possible to use the compositions of the invention to bond glass, as set out above, since when aromatic constituents are not used very much, and more particularly not at all, it is possible to achieve outstanding lightfastness, with additional acceleration of the reaction as compared with known polyurethane systems.

A further aspect of the present invention relates to a method of producing a two-component adhesive comprising an isocyanate-containing component A and an amine-containing component B,
component A comprising an isocyanate-terminated prepolymer having an isocyanate functionality of ≧1.7, preferably of 1.7<f_{NCO}<3, more preferably in the range from 2 to 3; and
component B comprising at least one diamine and/or polyamine, preferably a polyetherdiamine and/or polyetherpolyamine,
   and where the stoichiometric ratio of isocyanate groups in component A to amine groups in component B is set to about 0.5 to about 2, preferably about 0.9 to about 1.2, more preferably about 1.

The invention accordingly relates in a further aspect to the use of an isocyanate-containing component A and an amine-containing component B,
component A comprising an isocyanate-terminated prepolymer having at least two isocyanate groups, in particular one polyurethane prepolymer; and
component B comprising at least one diamine and/or polyamine, preferably a polyetherdiamine and/or polyetherpolyamine,
   as a two-component adhesive more particularly for the bonding of wood materials. No such use for these two components has hitherto been proposed in the art; the surprising, advantageous properties in the context of their use as a two-component adhesive, more particularly in the bonding of wood materials, have been described above.

The invention further relates to an assembly of components, more particularly construction members for structural wood construction, the assembly having been produced substantially by means of a two-component adhesive as described above.

Furthermore, in a further aspect, the invention relates to a system for the individualized provision of a two-component adhesive more particularly for the bonding of wood materials, comprising
at least one component A, comprising an isocyanate-terminated prepolymer (or a mixture of prepolymers) having an isocyanate functionality of ≧1.7, preferably of 1.7<f_{NCO}<3, more preferably in the range from 2 to 3; and
at least two alternative components B, each comprising at least one different diamine and/or polyamine, preferably a polyetherdiamine and/or polyetherpolyamine.

By means of such a system (in the sense of an ordered provision for common use (kit of parts)) it is possible for a two-component adhesive of the invention to be provided in an individualized way, surprisingly simply and flexibly, exclusively via the component B to be chosen on the part of the user in a manner specific to the application.

The invention is elucidated in greater detail below with reference to working examples, without the subject matter of the invention being restricted to these embodiments.

As component A, Desmodur® E23 from Bayer AG (Leverkusen, DE) was used.

In the compositions described in more detail below, the following mixtures were used as components B (viscosity, Brookfield, 20° C.: approximately 250 mPa*s):

| Identification code: | M 3 | M 320 | M 323 |
|---|---|---|---|
| Jeffamine D-2000 | 21.25 | 21.25 | 21.25 |
| Jeffamine T-5000 | 3.75 | 3.75 | 3.75 |
| Unilink 4200 | 75 | 65 | 70 |
| Härter DT | — | 10 | 5 |
| Total | 100.00 | 100.00 | 100.00 |

(All figures in g)

The following two-component adhesives were produced:

### EXAMPLE 1

### Desmodur® E23+M3

Mixing ratio: (Vol.) 100:74.2,
(wt.) 100:65.7
Potlife of 20 g of the mixture in the laboratory: 2 min
Potlife with mechanical mixing: 1 min 15 sec

### EXAMPLE 2

### Desmodur® E23+M323

Mixing ratio: (Vol.) 100:71.0,
(wt.) 100:62.8
Potlife of 20 g of the mixture in the laboratory: 1 min 05 sec
Potlife with mechanical mixing: 30-35 sec

### EXAMPLE 3

### Desmodur® E23+M320

Mixing ratio: (Vol.) 100:67.9,
(wt.) 100:60.1
Potlife of 20 g of the mixture in the laboratory: 1 min
Potlife with mechanical mixing: 20-25 sec.
The following bonds (beech) were implemented using the abovementioned two-component adhesives and then analysed:

| | Ex. 1 | | Ex. 2 | | Ex. 3 | |
|---|---|---|---|---|---|---|
| C1 EN 12765 (Target ≧ 10 N/mm²) | | | | | | |
| precise fit value at break | 12.7 | N/mm² | 13.1 | N/mm² | 11.6 | N/mm² |
| aspect at break | 100% | MF | 100% | MF | 100% | MF |
| joint 0.5 mm value at break | 8.8 | N/mm² | 9.2 | N/mm² | Not | |
| aspect at break | 100% | MF | 100% | MF | determined | |
| C3 EN 12765 (Target ≧ 4 N/mm²) | | | | | | |
| precise fit value at break | 4.6 | N/mm² | 4.4 | N/mm² | 3.8 | N/mm² |
| aspect at break | 100% | AF | 100% | AF | 100% | AF |
| joint 0.5 mm value at break | 5.42 | N/mm² | 2.96 | N/mm² | Not | |
| aspect at break | 100% | AF | 100% | AF | determined | |
| EN 14257 (Target ≧ 7 N/mm²) | | | | | | |
| 1 h at 80° C. | 8.3 | N/mm² | 9.2 | N/mm² | 9.0 | N/mm² |
| value at break | 95% | AF | 40% | AF | 70% | AF |
| aspect at break | 5% | MF | 60% | MF | 30% | MF |
| Cold storage | | | | | | |
| 24 h at 20° C., broken cold | 11.2 | N/mm² | 12.1 | N/mm² | 12.0 | N/mm² |
| value at break | 95% | MF | 85% | MF | 100% | MF |
| aspect at break | 5% | CF | 15% | AF | | |
| HDF - HDF C1 EN 12765 | | | | | | |

| | | | | | |
|---|---|---|---|---|---|
| Precise fit value at break | 3.6 | N/mm² | 3.9 | N/mm² | Not |
| aspect at break | 100% | MF | 100% | MF | determined |

Key:
HDF: high-density fibreboard (Pavatex Homadur, untreated, 5 mm, sanded both sides);
EN 14257: DIN EN 14257, September 2006 version;
EN 12765: DIN EN 12765, September 2001 version;
MF: fracture in material;
CF: cohesive fracture of the adhesive layer;
AF: adhesive fracture between adhesive and substrate.

The two-component adhesives of the invention display outstanding adhesive properties not only on wood. On glass and aluminium, as well, high strengths are obtained, as shown by the following examples:

| Identification code: | M16 | M16b | M6 | M7 |
|---|---|---|---|---|
| Jeffamine D-2000 | 21.25 | 11.58 | 21.25 | 12.50 |
| Jeffamine T-5000 | | | 3.75 | 12.50 |
| Unilink 4200 | 37.50 | 20.44 | 37.50 | 75.00 |
| Härter DT | 37.50 | 20.44 | 37.50 | |
| Jeffamine T-403 | 3.75 | 2.04 | | |
| Aerosil R 202 | | 0.50 | | |
| Siliporite SA 1720 | | 5.00 | | |
| Millicarb | | 40.00 | | |

where (unless already indicated earlier on above):
Desmodur ® E 305: largely linear NCO prepolymer based on hexamethylene diisocyanate and an ether diol, Bayer;
Jeffamine ® T-403: polyoxypropylenetriamine (CAS 39423-51-3), Huntsman;
Aerosil ® R 202: synthetic, hydrophobic silicon dioxide, Degussa;
Siliporite ® SA1720: molecular sieve (alkali metal and alkaline earth metal aluminosilicate; type A zeolite), CECA, Arkema Group;
Millicarb ®-OG: natural, very fine and readily dispersible CaCO₃ in powder form, prepared from a pure, white limestone, Omya AG

| | Comp. A | | | |
|---|---|---|---|---|
| | Desmodur | Desmodur | Desmodur | Desmodur |
| | E305 | E305 | E305 | E23 |
| Comp. B | M 16 | M 16b | M 6 | M 7 |
| Mixing ratio | 100:39.2 | 100:71.8 | 100:40.5 | 100:66.1 |
| by weight | | | | |
| Mixing ratio | 100:42.7 | 100:78.3 | 100:44.1 | 100:74.7 |
| by volume | | | | |
| Potlife | approx. 2 | approx. 2 | approx. 2 | approx. 2 |
| | min 30 | min 25 | min | min 30 |
| Tensile shear | 12.8; AF | 18.2; 30% CF | 11.8; AF | 7.9; AF |
| strength | | | | |
| Al 21 d | | | | |
| Tensile shear | >6; MF | 5.1; AF | >6; MF | >6; MF |
| strength | | | | |
| Glass 21 d | | | | |
| Tensile shear | 13.2; 75% W | 10.3; 100% W | 12.7; 70% W | 12.6; 60% W |
| strength | | | | |
| Wood 21 d | | | | |

Strength data in MPa
W: Break in wood
Test equipment: Tensile testing machine Instron 5567; jaw separation rate 50 mm/min.

These tests show that the common view that sufficiently robust adhesive bonds cannot be produced using adhesives which react extremely rapidly is not true. Surprisingly, the relevant standards are met—and, in some cases, significantly exceeded—by the two-component adhesives of the invention.

1-10. (canceled)

11. Two-component adhesive for bonding wood materials, the adhesive comprising an isocyanate-containing component A and an amine-containing component B, wherein
component A comprises an isocyanate-terminated prepolymer having an isocyanate functionality of ≧1.7; and
component B comprises at least one diamine and/or polyamine, and wherein
the stoichiometric ratio of isocyanate groups in component A to amine groups in component B is about 0.5 to about 1.2.

12. Two-component adhesive according to claim 11, characterized in that the isocyanate-terminated prepolymer in component A is a polyurethane prepolymer.

13. Two-component adhesive according to claim 111, further comprising an additive selected from the group consisting of plasticizers; solvents; organic and inorganic fillers; fibres; pigments; rheology modifiers; siccatives; heat, light and UV radiation stabilizers; flame retardants; wetting agents; flow control agents; de-volatilizers; defoamers; fungicides or fungal growth inhibitors; and mixtures thereof.

14. Two-component adhesive according to claim 11, wherein, when joining wood
a bond strength C1 to DIN EN 12765 (precise-fit joint) of ≧10N/mm², preferably of ≧12N/mm²; and/or
a bond strength C1 to DIN EN 12765 (0.5 mm joint) of ≧7.5N/mm², preferably of ≧9N/mm²; and/or
a water resistance C3 (conditioning sequence 3) to DIN EN 12765 (precise-fit joint) of ≧4N/mm², preferably of ≧5N/mm²; and/or
a water resistance C3 to DIN EN 12765 (0.5 mm joint) of ≧3N/mm², preferably of ≧4N/mm²; and/or
a heat resistance to DIN EN 14257 (precise-fit joint) of ≧7N/mm², preferably of ≧9N/mm²,
is obtainable.

15. Method of bonding wood substrates, comprising the step of applying a two-component adhesive according to claim 11 to at least one of the substrates; and joining the substrates.

16. Method of producing a two-component adhesive comprising an isocyanate-containing component A and an amine-containing component B, wherein
component A comprises an isocyanate-terminated prepolymer having an isocyanate functionality of ≧1.7; and
component B comprising at least one diamine and/or polyamine, and wherein the stoichiometric ratio of isocyanate groups in component A to amine groups in component B is set to about 0.5 to about 1.2.

17. Kit of parts for the individualized provision of a two-component adhesive comprising
at least one component A, comprising an isocyanate-terminated prepolymer having an isocyanate functionality of ≧1.7; and
at least two alternative components B, each comprising at least one different diamine and/or polyamine.
